(19) United States
(12) Patent Application Publication
(10) Pub. No.: US 2015/0145674 A1
(43) Pub. Date: May 28, 2015

(54) Caretaking Communication Bracelet

(71) Applicants: Jan Rydfors, San Mateo, CA (US); Rebecca Padnos Altamirano, Menlo Park, CA (US)

(72) Inventors: Jan Rydfors, San Mateo, CA (US); Rebecca Padnos Altamirano, Menlo Park, CA (US)

(21) Appl. No.: 14/468,289

(22) Filed: Aug. 25, 2014

Related U.S. Application Data
(60) Provisional application No. 61/871,295, filed on Aug. 28, 2013.

(51) Int. Cl. G08B 21/02; G06F 19/00; A44C 5/00

(52) U.S. Cl. CPC G08B 21/02; A44C 5/0007; G06F 19/3418
USPC 340/539.12

(57) ABSTRACT

A caretaker's communication bracelet that can record and asynchronously transmit a message to another similar bracelet, a smartphone or mobile phone, or a computer, via a cloud server.

### CROSS-REFERENCE TO RELATED APPLICATIONS

The present application takes priority from U.S. Provisional App. No. 61/871,295, filed Aug. 28, 2013, which is herein incorporated by reference.

### BACKGROUND

As people's work hours extend longer and longer, many people find themselves caught in a bind between their work schedules and their family obligations. Those who have small children, elderly parents, or disabled or ill family members need to be able to respond instantly to an emergency affecting the person they are taking care of—but since most people are inundated by emails, phone calls, text messages, and other communications all the time, it is often hard to distinguish true emergencies from the background noise. Furthermore, even the busiest of busy professionals would occasionally like to “unplug” from the stress of constantly responding to emails or phone calls and leave the phone at home—but would still like to receive emergency messages regarding a family member.

Many companies are providing “Medic Alert” types of services so that elderly or disabled people can get help in an emergency situation. Typically, such a product is a wearable device with a button that the user can press in an emergency, the device being in communication with an operator who can direct the appropriate emergency services to the person. Such devices are typically sold with subscriptions to the operator helpline, and do not signal the user's family. This typically limits their utility to life-threatening emergencies (i.e. the kind of emergencies that would involve a 911 call) rather than milder crises.

A need exists for a simple, wearable device that a medically fragile, elderly, disabled, or young user can use to signal their caretaker that they are in need of help.

A need also exists for an emergency alert device that supports various existing communication modes such as SMS, CDMA, and others, rather than relying on a specialized and expensive subscription to a dedicated network.

A need also exists for a simple, everyday communication device for individuals in need of care that is easy to use for someone who is visually impaired, has cognitive challenges, has difficulty operating a typical touchscreen interface, or is not technologically savvy.

### SUMMARY OF THE INVENTION

An object of the present invention is to provide a system and method to enable a user to efficiently send an emergency message to one or more people.

Another object of the present invention is to provide a system and method to enable a user to automatically record and send an emergency message to one or more people's cellular phones, computers, or dedicated devices.

Another object of the present invention is to provide a system and method to enable a caretaker to communicate with a patient.

The system of the present invention comprises at least one secondary bracelet worn by a patient in need of care. The secondary bracelet preferably comprises a communication module, a microphone, a speaker, and a power source such as a battery or a solar panel. The system of the present invention also comprises a server that can communicate with the at least one secondary bracelet wirelessly. The communication protocol can be any wireless communication protocol such as cellular data, SMS, wi-fi, and so on. The server can be configured to link each secondary bracelet with at least one contact method for a caretaker (email, phone, SMS, and so on). Multiple contact methods are possible. This configuring step can be done by means of a website or a mobile app. Messages are then transmitted from the secondary bracelet to the server and then to the contact method specified for that secondary bracelet during the configuration step.

In an embodiment, a caretaker wears a similar bracelet (primary bracelet). The primary bracelet can be configured at the server to be linked to the primary bracelet. In an event requiring an emergency response, the server can receive a message from a secondary bracelet and then convey it to the primary bracelet. The primary bracelet can then alert the caretaker that the patient needs assistance—either by replaying a recorded message from the patient, by vibrating, or by transmitting an automated message generated by the server or by the secondary bracelet.

The secondary bracelet may be able to record a brief audio message from the patient and transmit the message to the server, which then transmits it to the caretaker through the contact method specified on the server during the configuration step. In an embodiment, the secondary bracelet may also be able to receive a brief audio message from a caretaker, recorded either by the primary bracelet or by another device.

In an embodiment, a live voice phone call can be initiated between a secondary bracelet and a caretaker's device—whether a primary bracelet or a mobile phone.

In an embodiment, the secondary bracelet is in communication with a tracking device that measures some parameter of the patient; for example, an implantable medical device such as an insulin pump. If the tracking device indicates that the patient's condition requires care, the secondary bracelet can send an automated message to the server, which then transmits it to the caretaker through the contact method specified on the server during the configuration step. The caretaker can then be alerted when the patient's condition requires the caretaker's assistance.

In an embodiment, a bracelet can be configured to function as a primary or a secondary bracelet by the user. This can be done by means of a mobile app or a website.

### LIST OF FIGURES

FIG. 1 shows a diagram of the preferred embodiment of the system of the present invention.

FIG. 2 shows a block diagram of the preferred embodiment of the bracelet.

FIG. 3 shows a state diagram for user interaction with the bracelet.

FIG. 4 shows a state diagram for user interaction with the bracelet.

### DETAILED DESCRIPTION

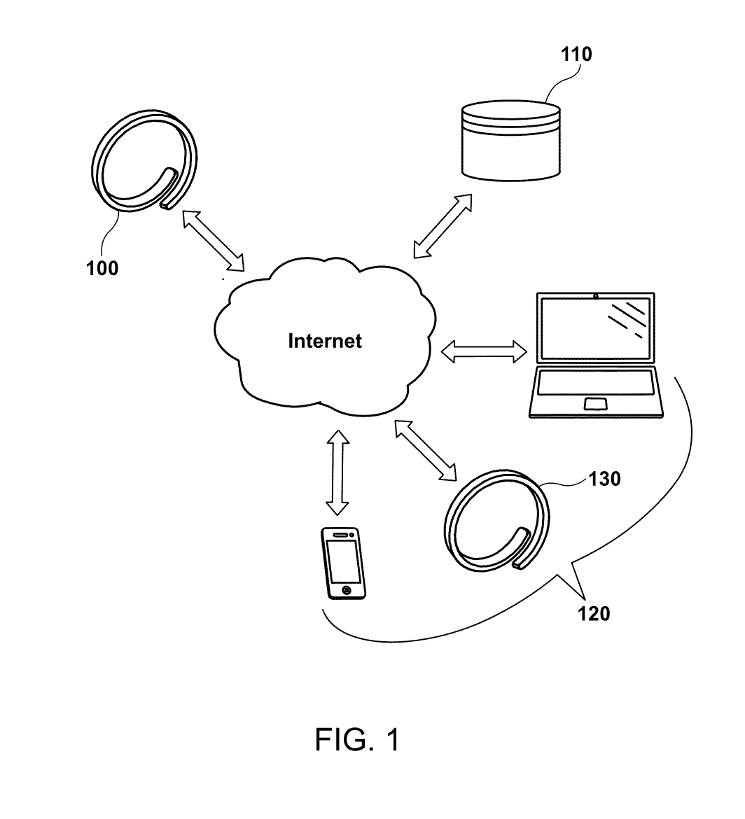

FIG. 1 shows a system of the present invention. A secondary bracelet 100 is provided to a user who requires assistance. For example, such a user may be an elderly person who is vulnerable to falls; a child; an ill person who may require emergency medical assistance; a pregnant woman who is close to giving birth; a disabled person who may require emergency assistance; and other people who may require emergency help from a caretaker or multiple caretakers. The secondary bracelet 100 comprises a communication module enabling it to communicate with a server 110. The server 110 comprises a database linking each secondary bracelet 100 with a list of emergency contacts 120. Such contacts may be email addresses, phone numbers, SMS numbers, app ID's, and so on. When an alert is generated by the secondary bracelet 100, it is received by the server 110, and sent to the list of emergency contacts 120. In an embodiment, a primary bracelet 130 may be worn by a caretaker, and may also be configured to receive the alerts sent by the secondary bracelet. This would enable the caretaker to receive alerts even when they are not near a computer or smartphone, and to prioritize the alerts received from the user over other interruptions such as phone calls and emails.

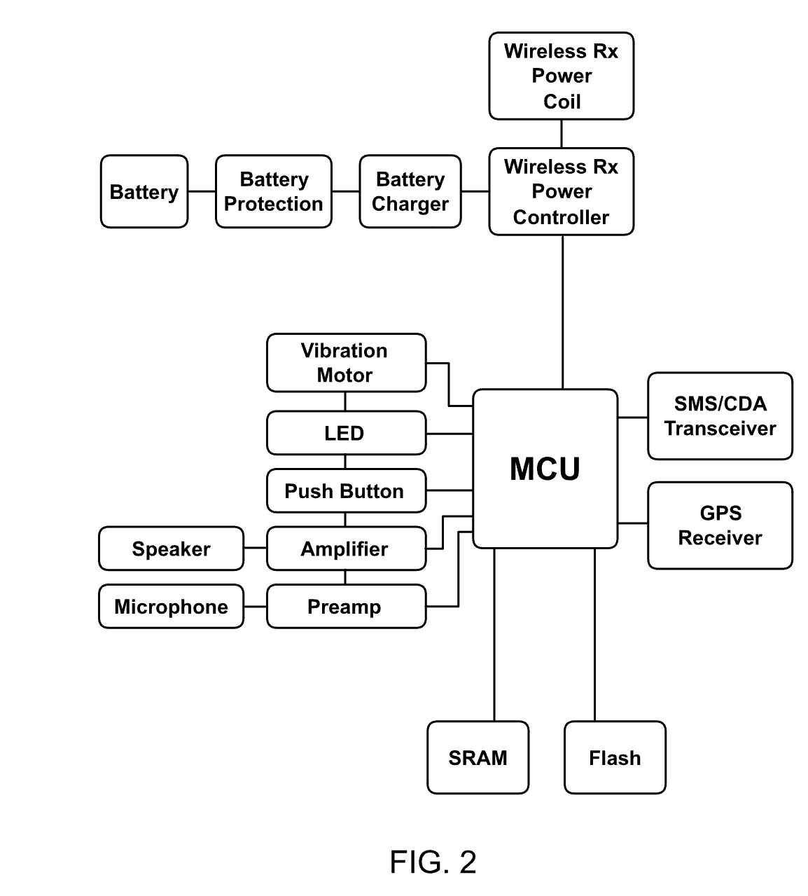

The secondary bracelet 100, as well as the primary bracelet 130, preferably comprises a speaker and microphone combination, a control button, a LED indicator, a location module, a communication module, and a power source. As shown in FIG. 2, the function of these components is controlled by a microcontroller unit 200. The microcontroller unit 200 is connected to a SRAM chip 210 and a Flash memory 220. The power source is preferably a rechargeable battery 230 that is charged via a USB connector, but can be a disposable battery, a solar panel, or any other power supply that can provide the requisite amount of power to the bracelet. User interface components such as a vibration motor 240, an LED 250, a push button 260, and a speaker/microphone combination 270, enable the user to interact with the bracelet.

The speaker and microphone combination 270 preferably enables the user to record a brief emergency message that can then be sent to one or more caretakers. Preferably, the user can record that message by pushing the control button 260 and speaking into the microphone. The microphone is preferably sensitive enough to record the sound of a human voice at a reasonable distance. The message is then transmitted asynchronously to the designated user or users via the communication module.

The communication module preferably comprises at least a SMS/CDMA transceiver 280, which is able to access the Internet and communicate with a server. In other embodiments, other communication devices may also be incorporated.

In the preferred embodiment, the bracelet also comprises an accelerometer. The accelerometer may be used to identify motion patterns that indicate that the user is in need of care. For example, violent motion of the accelerometer may indicate that the user is having a seizure. If the accelerometer is perfectly still, it may indicate that the user is unconscious. In the preferred embodiment, if the accelerometer indicates any emergency condition (i.e. a seizure, unconsciousness, or any other atypical state), the bracelet automatically sends an alert to the server, which is then transmitted to the designated emergency contacts.

The communication module preferably transmits the message to a cloud server, from which it is then transmitted to a target device. The target device may be a cell phone, a computer, a tablet, or another bracelet. The message may be transmitted by email, SMS, phone, or any other means of communication known in the art that can transmit a prerecorded voice message or a text message. The user can set the preferred communication method or methods while configuring the device. The message may be sent to several users simultaneously, and may be sent by different communication methods to different users.

In an embodiment of the invention, the bracelet also comprises a location module 290. The location module may be configured to send location data along with each message to let the caretaker or caretakers know where the user is located. The location module may also be configured to alert the caretaker automatically when a user leaves a predetermined area (say, when a dementia patient or a child wanders out of the house) and to inform the caretaker of the user's location. The location module preferably uses cell tower triangulation to determine the user's approximate location, but may also use GPS, wi-fi, or any other means of determining the location of the user.

The bracelet may be configured to function either in “primary” or “secondary” mode. In “primary” mode, the bracelet functions as a hub and receiver of all alerts in a given group of bracelets. In “secondary” mode, the bracelet can send out emergency alerts but does not receive them. This means that a caretaker wearing a bracelet can receive emergency messages from several different users (say, a young child and an elderly grandparent), but the child does not receive emergency messages from the grandparent.

The bracelet may act as a “walkie-talkie” style of communicator, transmitting recorded voice messages to another bracelet. This enables the primary bracelet wearer to respond to the emergency message sent by a secondary bracelet wearer, to let them know that help is on the way, or to give them instructions on what to do. The bracelet preferably comprises a speaker configured in such a way that it can play back those messages. In an embodiment, the bracelet also comprises a vibration module that can provide a silent alarm to the wearer.

The bracelet preferably comprises a processor and memory that can store unplayed messages/alerts in the order received. In the preferred embodiment, only one played message is stored at a time, and it will be stored for a configurable amount of time after initial playback.

The bracelet may be configured via a website or a smartphone app. Such a website or app can set the emergency contact information for the bracelet, set the preferred communication modes for each emergency contact, enable or disable the GPS functions, and configure the bracelet to be either primary or secondary.

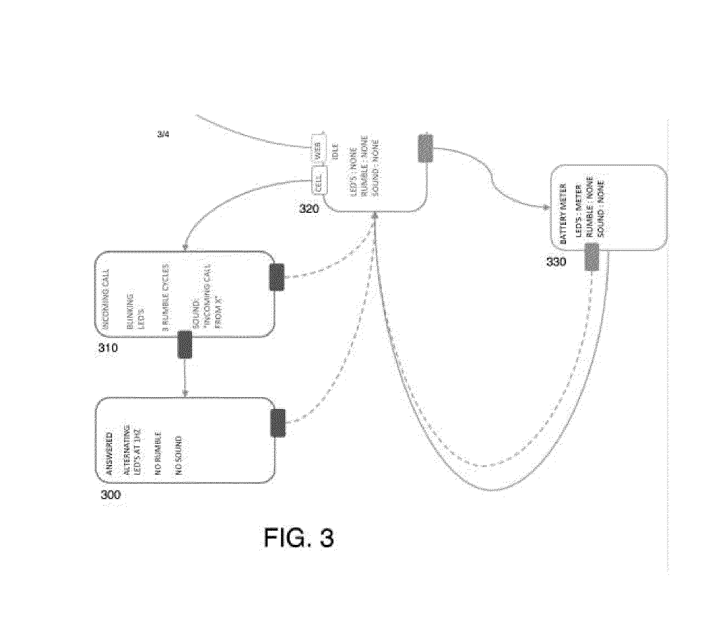

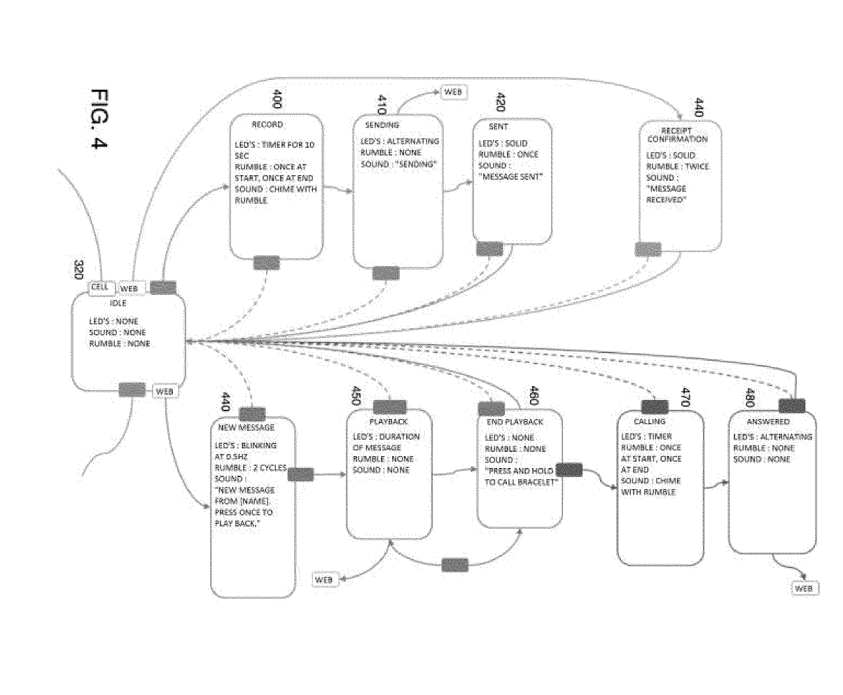

FIGS. 3 and 4 show a state diagram for user interactions with the preferred embodiment of a primary bracelet. In an idle state 320, the bracelet is inert; the LED's do not blink, the vibration module does not rumble, and no sound is generated. When an incoming call is received 310, the LED's blink at a 1 Hz frequency and the vibration module rumbles 3 times, and then keeps rumbling at 2 rumbles every 0.75 Hz. In an embodiment, the speaker on the bracelet can say “Incoming call from [name]. Press once to answer”. The caretaker can then press the button on the bracelet to answer the call 300. While the call is ongoing, the LED's blink at a 1 Hz frequency until the call is ended.

When the battery is low 330, the meter LED begins to blink. This alerts the user that it is time to recharge the battery.

If a user wishes to record a brief message 400, they can press the push button. The timer LED will light up for 10 seconds, and the vibration module will rumble once to indicate the start of recording and once to indicate the end of recording. A sound can also be configured to chime at the same time. After the message is recorded, it can be sent to the server 410. The LED's will blink in alternating fashion until the message is sent, and a sound can be configured to say “Sending”. If the message cannot be sent at the time, an automated message can alert the user to that fact. Once the message is sent 420, the LED's light up solidly for 2 seconds, and the vibration module rumbles once.

Once the message is received by the recipient 430, the bracelet alerts the user to this fact by having the LED's light up solid for 2 seconds and having the vibration module rumble twice; also, a sound can be configured to say “Message Received”. This can provide extra reassurance to the patient that help is on the way.

When a new message is received by the primary bracelet 440, the LED's blink at 0.5 Hz and the vibration module rumbles as shown in the Figure. A sound can also be configured to say “New Message from [name], press once to playback”. The user can then play back the message by pressing the button 450. The LED lights up for the duration of the message. At the end of the message 460, a sound is configured to say “Press and Hold to call Bracelet”; the caretaker can then initiate a call by pressing the button. While the primary bracelet calls the secondary bracelet 470, the LED's light up until the call is answered, and once the call is answered 480, the LED's alternate.

The bracelet is preferably waterproof, to enable a user to wear it in the shower or bath. In an embodiment, the bracelet is designed in such a way that the user cannot take it off without assistance; this is helpful for dementia patients or children. In an embodiment, the bracelet sends an alert to the server when a user tries to remove the bracelet.

In an embodiment, when an emergency message from a secondary bracelet is answered by at least one contact address (i.e. a smartphone, a computer, or a primary bracelet), an alert is sent to all the other contact addresses associated with the secondary bracelet, to inform them that the emergency message has been answered. This reduces stress on the caregivers.

While exemplary embodiments have been described above, those skilled in the art will readily realize that numerous changes, modifications, and substitutions may be made without departing from the spirit and scope of this invention, which is limited only by the appended claims.

1. A communication system for caretaking, comprising:
at least one secondary bracelet for use by a person in need of care, said secondary bracelet comprising:
a communication module, said communication module capable of sending and receiving messages;
a bracelet housing capable of securely attaching around a user's wrist;
a microphone;
a speaker;
a power source;
a processor and memory;
an accelerometer;
a location module for detecting location data;
at least one mobile device, said mobile device being one of the group comprising: smartphone, cellular phone, tablet, computer;
a server capable of communicating with the at least one secondary bracelet and the at least one mobile device;
wherein the server can be configured to receive messages from the at least one secondary bracelet and transmit them to at least one mobile device;
wherein the server can be configured to receive messages from the at least one mobile device and transmit them to the at least one secondary bracelet.

2. The system of claim 1, further comprising:
at least one primary bracelet for use by a caretaker, said primary bracelet comprising:
a communication module, said communication module capable of sending and receiving messages;
a bracelet housing capable of securely attaching around a user's wrist;
a microphone;
a speaker;
a power source;
a processor and memory;
an accelerometer;
a location module for detecting location data;
wherein the server can be configured to receive messages from a secondary bracelet and transmit them to at least one primary bracelet and at least one mobile device;
wherein the server can be configured to receive messages from at least one primary bracelet and transmit them to at least one secondary bracelet.

3. The system of claim 2, wherein the mobile device is one of the following: a cell phone, a smartphone, a tablet, a laptop, a computer.

4. The system of claim 1, wherein the server transmits messages by at least one of the following communication methods: email, text message, voice cellular call, app notification.

5. The system of claim 1, wherein the at least one secondary bracelet communicates with a monitoring device and sends a message to the server based on the data received from the monitoring device.

6. The system of claim 1, wherein the at least one primary bracelet can record an audio message and transmit the audio message to the server.

7. The system of claim 1, wherein the server is configured to link at least one secondary bracelet with at least one of the following group: at least one primary bracelet, at least one electronic device.

8. The system of claim 7, wherein a caretaker can configure the server by means of at least one of the following group: a website, a mobile app.

9. A method for providing patient care, comprising:
providing a secondary bracelet to be worn by a patient, said secondary bracelet comprising a communication module capable of communicating with a server, a speaker, a microphone, an accelerometer, a location module, and a memory;
configuring a server to indicate at least one of the following preselected contact addresses to reach at least one caretaker of a person wearing a secondary bracelet: email address, phone number, SMS number, smartphone app ID.
transmitting a message from the secondary bracelet to the server;
transmitting the message from the server to the preselected contact addresses.

10. The method of claim 9, wherein the message is recorded by the microphone of the secondary bracelet.

11. The method of claim 9, wherein the message is automatically generated by the secondary bracelet.

12. The method of claim 11, comprising:
communicating with a monitoring device worn by a person by means of the secondary bracelet;
automatically generating a message by the secondary bracelet based on the data received from the monitoring device;
transmitting the message from the secondary bracelet to the server;
transmitting the message from the server to the preselected contact addresses.

13. The method of claim 7, further comprising:
providing a primary bracelet to be worn by a caretaker, said primary bracelet comprising a communication module capable of communicating with a server, a speaker, a microphone, and a memory;
configuring a server to indicate at least one of the following preselected contact addresses to reach at least one caretaker of a patient wearing a secondary bracelet: email address, phone number, secondary bracelet ID, SMS number, smartphone app ID.
transmitting a message from the secondary bracelet to the server;
transmitting the message from the server to the preselected contact addresses.

14. The method of claim 7, further comprising:
configuring a bracelet to serve as a primary bracelet;
configuring a bracelet to serve as a secondary bracelet.

15. The method of claim 13, further comprising:
recording a message by means of the microphone of one of the following: the primary bracelet, a mobile device;
transmitting the message to the server;
transmitting the message from the server to the secondary bracelet.

16. The method of claim 13, further comprising:
preselecting a time to play the message;
playing the message at the preselected time.

17. The method of claim 13, further comprising:
sending an alert to the preselected contact addresses if the bracelet is removed.

18. The method of claim 13, further comprising:
initiating a live voice call between a secondary bracelet and a mobile device.

19. The method of claim 13, further comprising:
receiving a response from one of the preselected contact addresses;
sending an alert to all the other preselected contact addresses to indicate that a response was received from one of the preselected contact addresses.
